(19) United States
(12) Patent Application Publication
(10) Pub. No.: US 2026/0171865 A1
(43) Pub. Date: Jun. 18, 2026

(54) COLLECTOR RING FOR MOTOR, AND MOTOR

(71) Applicant: Schaeffler Technologies AG & Co. KG, Herzogenaurach (DE)

(72) Inventors: Yi DAI, Shanghai (CN); Jiancheng Huang, Shanghai (CN)

(73) Assignee: Schaeffler Technologies AG & Co. KG, Herzogenaurach (DE)

(21) Appl. No.: 18/707,664

(22) PCT Filed: Nov. 5, 2021
(86) PCT No.: PCT/CN2021/129052

§ 371 Date: May 6, 2024

(51) Int. Cl. H02K 5/22

(52) U.S. Cl. CPC H02K 5/225; H02K 2203/09

(57) ABSTRACT

A collector ring for a motor, and a motor. The collector ring has a connecting end, the connecting end comprising a base part and a welding part which is vertical relative to the base part; the base part is provided with a positioning hole and an elastic part the positioning hole being a through hole, the positioning hole being used to permit a stator wire outlet end of the motor to pass through, and the elastic part being formed so as to be capable of applying an elastic force to the stator wire outlet end along a first direction serving as a length direction of the base part, so that two opposite side surfaces of the stator wire outlet end along the first direction are in close contact with the base part and the welding part, respectively.

### CROSS-REFERENCE TO RELATED APPLICATIONS

This application is the U.S. National Phase of PCT Appln. No. PCT/CN2021/129052, filed Nov. 5, 2021, the entire disclosures of which is incorporated by reference herein.

### TECHNICAL FIELD

The present application relates to the field of motors, and in particular, to a collector ring for a motor, and a motor.

### BACKGROUND

A drive motor has to withstand vibration loads in the application environment of new energy vehicles. A collector ring is connected to a stator wire outlet end by welding, in which the mechanical strength of welding spots is relatively low, causing the welding spots to be prone to failure in a vibration test. There are possible solutions to reduce the impact of vibration loads on the welding spots and to address failure of the welding spots, including:
(1) Make the collector ring lightweight. However, the collector ring comprises a three-phase copper bar, an injection molding part and a connecting part, and the weight of the collector ring can only be reduced to a limited extent in consideration of the large current that the collector ring needs to carry and safety requirements for electrical clearance.
(2) Provide additional fixing points for the collector ring. Although this may significantly reduce the stress borne at the welding spots, such a solution could easily be limited in terms of space and assembly, and it is difficult to find suitable support points on a motor housing.
(3) Increase the number of the welding spots so as to increase the number of the support points. The stress at a single welding spot can be reduced by increasing the number of the welding spots, but the requirement for the true position of the stator wire outlet end becomes stricter, which increases the manufacturing cost and the scrap rate of a stator.

### SUMMARY

The purpose of the present application is to overcome or at least ameliorate shortcomings of the above prior art, and to provide a collector ring for a motor, and a motor, so as to reduce the stress, which is generated under the action of vibration and other external forces, at welding spots of the collector ring and the stator wire outlet end in a centralized manner, and thus prevent the welding spots from being prone to failure under vibration loads.

The present application provides a collector ring for a motor. The collector ring has a connecting end, the connecting end comprising a base part and a welding part which is vertical relative to the base part; the base part is provided with a positioning hole and an elastic part, the positioning hole being a through hole, the positioning hole being used to permit a stator wire outlet end of the motor to pass through, and the elastic part being formed so as to be capable of applying an elastic force to the stator wire outlet end along a first direction serving as a length direction of the base part, so that two opposite side surfaces of the stator wire outlet end along the first direction are in close contact with the base part and the welding part, respectively.

In at least one embodiment, a dimension of the positioning hole along a second direction is equal to that of the stator wire outlet end along the second direction, the first direction is perpendicular to the second direction, and the second direction is consistent with a width direction of the base part.

In at least one embodiment, the connecting end further comprises a limiting part, the limiting part comprises a transition part and the welding part, the welding part is connected to the base part through the transition part, the limiting part and the elastic part are located on two opposite sides of the positioning hole in the first direction, and under the action of the elastic force applied by the elastic part, the stator wire outlet end can abut against the welding part.

In at least one embodiment, the base part and the limiting part are integrally formed.

In at least one embodiment, the elastic part and the base part are integrally formed.

In at least one embodiment, the positioning hole and the elastic part are formed simultaneously. After the base part is punched, a part bending and warping from the base part is the elastic part, and a hollowed-out part formed due to warping is the positioning hole.

In at least one embodiment, a dimension of the transition part along a second direction is greater than that of the welding part along the second direction, the dimension of the welding part along the second direction is greater than that of the stator wire outlet end along the second direction, the second direction is perpendicular to the first direction, and the second direction is consistent with the width direction of the base part.

In at least one embodiment, the welding part is offset from the transition part toward a side where the elastic part is located.

The present application further provides a motor, which comprises a stator wire outlet end and the collector ring for a motor according to any one of the above technical solutions, and the stator wire outlet end is connected to the welding part of the collector ring by welding.

In at least one embodiment, the base part is connected to an axial end face of a stator of the motor, and the welding part extends along an axial direction of the stator.

By adopting the above technical solutions, the stator wire outlet end is positioned in such a way that the stress generated due to the position error of the stator wire outlet end is smaller, so that the welding stability is higher, and the welding spot has a higher strength. As a result, the welding spot can withstand vibration loads and is not prone to failure.

### BRIEF DESCRIPTION OF THE DRAWINGS

FIG. 1 shows a structural schematic diagram of a collector ring for a motor, and a stator wire outlet end, according to embodiments of the present application.

FIG. 2 shows a structural schematic diagram from another perspective of a collector ring for a motor, and a stator wire outlet end, according to embodiments of the present application.

FIG. 3 shows a collector ring for a motor according to embodiments of the present application.

### DETAILED DESCRIPTION

Exemplary embodiments of the present application will be described below with reference to the accompanying drawings.

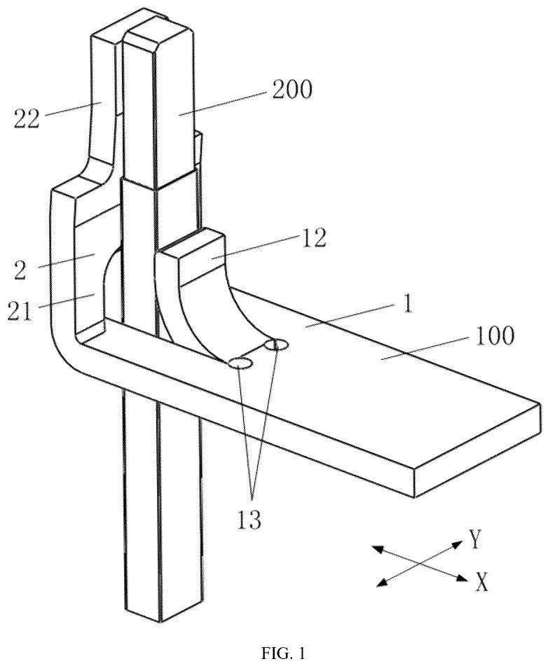

Referring to FIGS. 1 to 3, the present application provides a motor, which comprises a stator and a collector ring. The collector ring has a connecting end 100, the stator has a stator wire outlet end 200, and the connecting end 100 is connected to the stator wire outlet end 200 by welding to achieve an electrical connection. The motor may be, but is not limited to being, a motor used in new energy vehicles.

The motor here may be an electric motor for converting electric energy into mechanical energy, a generator for converting mechanical energy into electric energy, or a machine (motor) that can be used for both driving and generating electricity.

The connecting end 100 comprises a base part 1 and a limiting part 2, the connecting end 100 is in the shape of a bent plate as a whole, the limiting part 2 is connected to the base part 1, and the base part 1 and the limiting part 2 may be perpendicular to each other (including substantially perpendicular). The base part 1 and the limiting part 2 may be integrally formed, for example, by bending a metal plate to form the base part 1 and the limiting part 2.

The base part 1 may be used for connection to the stator of the motor, and in particular for fixed connection to the axial end face of the stator of the motor. At least a part of the base part 1 may be coated with an insulating material such as plastic, and the base part 1 may further comprise a connecting part for introducing external electric power into the stator wire outlet end 200 or guiding electric power out from the stator wire outlet end 200.

The base part 1 may be provided with a positioning hole 11 and an elastic part 12, the positioning hole 11 is a through hole, and the positioning hole 11 is used to permit the stator wire outlet end 200 to pass through. The positioning hole 11 may be a rectangular hole, edges of the rectangular hole extend along the first direction X and the second direction Y, and the first direction X is perpendicular to the second direction Y. A dimension of the positioning hole 11 along the second direction Y may be equal to that of the stator wire outlet end 200 along the second direction Y, so that the stator wire outlet end 200 cannot move along the second direction Y within the positioning hole 11.

The positioning hole 11 and the elastic part 12 may be formed simultaneously through a punching process. When making the connecting end 100, the punching process may be performed prior to the bending process for the formation of the base part 1 and the limiting part 2.

Optionally, by punching the metal plate along a semi-enclosing line, such as a U-shaped line, and then making the part enclosed by the U-shaped line bent and warped, the positioning hole 11 and the elastic part 12 may be formed simultaneously, with the warped part being the elastic part 12, and the hollow ed-out part formed due to warping being the positioning hole 11. After the punching process, the elastic part 12 may be rectangular or rounded rectangular before being bent. Through the above-mentioned process, the elastic part 12 and the base part 1 are integrally formed, and the elastic part 12 may be bent into an arc shape and has elasticity.

As shown in FIG. 1, a base end of the elastic part 12 may have a process hole 13 formed by punching. The process hole 13 may be a round hole. The process hole 13 may be located at the corner of the semi-enclosing line. In addtion, the process hole 13 may reduce the stress of the connecting end 100.

It will be appreciated that the U-shaped line may run across the base part 1 and the limiting part 2, and therefore, when the elastic part 12 is formed, a hole (not the positioning hole 11) may also be formed on the limiting part 2, so that the length of the elastic part 12 can be greater without changing the dimension of the positioning hole 11 along the first direction X, and thus the elastic part is more stably pressed against the stator wire outlet end 200.

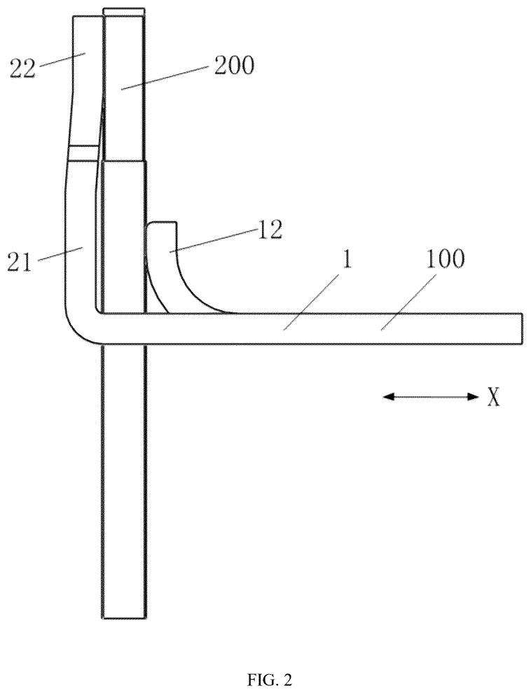

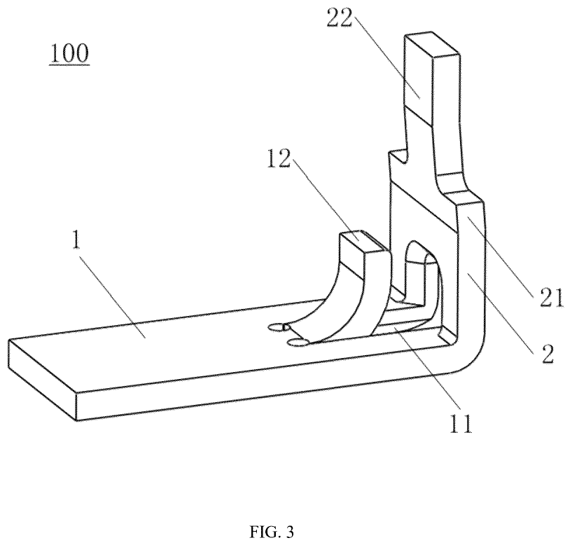

As shown in FIGS. 2 and 3, the stator wire outlet end 200 passes through the positioning hole 11. The elastic part 12 is in close contact with one side surface of the stator wire outlet end 200, and applies an elastic force to the stator wire outlet end 200 to cause the other side surface, in the opposite direction, of the stator wire outlet end 200 to be in close contact with the welding part 22, so that the stator wire outlet end 200 cannot move along the first direction X within the positioning hole 11. The stator wire outlet end 200 cannot move in the first direction X and the second direction Y, which may reduce or eliminate the true position error of the stator wire outlet end 200 in the first direction X and the second direction Y, and reduce the stress at the welding spots. As a result, the welding stability is higher, the welding spot has a higher strength, and thus tough requirements for vibration loads in the vehicular environment can be easily satisfied.

The limiting part 2 comprises a transition part 21 and a welding part 22. The limiting part 2 is connected to the base part 1 through the transition part 21. The welding part 22 may extend along (including substantially along) the axial direction of the stator of the motor. A dimension of the transition part 21 along the second direction Y may be greater than that of the welding part 22 along the second direction Y. The dimension of the welding part 22 along the second direction Y may be slightly greater than that of the stator wire outlet end 200 along the second direction Y. For example, on both sides of the welding part 22, 5% to 20% of it exceeds the edge of the stator wire outlet end 200. In other words, the dimension of the welding part 22 in the second direction Y (also called the width) may be 110% to 140% of that of the stator wire outlet end 200 in the second direction Y (also called the width). The dimension of the transition part 21 along the second direction Y may be equal to that of the base part 1 along the second direction Y.

The welding part 22 may be offset from the transition part 21 to the side where the elastic part 12 is located, so that the stator wire outlet end 200 is in contact with the welding part 22 under the action of the elastic force applied by the elastic part 12, and a gap exists between the stator wire outlet end 200 and the transition part 21.

The connecting end 100 may be connected to the stator wire outlet end 200 by welding. Further, the stator wire outlet end 200 is connected to the welding part 22 of the collector ring 100 by welding. The stator wire outlet end 200 is positioned in such a way that the stress generated by the stator wire outlet end 200 due to position error is smaller, so that the welding stability is higher, and the welding spot has a higher strength. As a result, the welding spot can withstand vibration loads and is not prone to failure. The welding part 22 is in close contact with the stator wire outlet end 200, and the width of the welding part 22 is slightly greater than that of the stator wire outlet end 200, which also helps to improve the welding stability.

Certainly, the present application is not limited to the above-mentioned embodiments, and those skilled in the art can make various modifications to the above-mentioned embodiments of the present application under the teaching of the present application without departing from the scope of the present application.
(i) In the above embodiments, the length of the elastic part 12 is greater, so that a punching hole is also formed in the limiting part 2. However, the punching hole is not necessary. A punching hole may be only formed in the base part, with no punching hole being formed in the limiting part.
(ii) In the above embodiments, the metal plate is punched along the U-shaped line. However, the elastic part may be formed just by punching the metal plate along a semi-enclosing, non-closed line.

### LIST OF REFERENCE NUMERALS

100 Connecting end;
200 Stator wire outlet end;
1 Base part;
11 Positioning hole;
12 Elastic part;
13 Process hole;
2 Limiting part;
21 Transition part;
22 Welding part;
X First direction;
Y Second direction.

1. A collector ring for a motor, the collector ring comprising:
a connecting end, the connecting end including a base part and a welding part which is vertical relative to the base part, the base part is provided with a positioning hole and an elastic part, the positioning hole is a through hole, the positioning hole is used to permit a stator wire outlet end of the motor to pass through, and the elastic part is formed so as to be capable of applying an elastic force to the stator wire outlet end along a first direction serving as a length direction of the base part, so that two opposite side surfaces of the stator wire outlet end along the first direction are in close contact with the base part and the welding part, respectively.

2. The collector ring for a motor according to claim 1, wherein a dimension of the positioning hole along a second direction is equal to a dimension of the stator wire outlet end along the second direction, the first direction is perpendicular to the second direction, and the second direction is consistent with a width direction of the base part.

3. The collector ring for a motor according to claim 1, wherein the connecting end further comprises a limiting part, the limiting part comprises a transition part and the welding part, the welding part is connected to the base part through the transition part, the limiting part and the elastic part are located on two opposite sides of the positioning hole in the first direction, and under the action of the elastic force applied by the elastic part, the stator wire outlet end can abut against the welding part.

4. The collector ring for a motor according to claim 3, wherein the base part and the limiting part are integrally formed.

5. The collector ring for a motor according to claim 1, wherein the elastic part and the base part are integrally formed.

6. The collector ring for a motor according to claim 1, wherein the positioning hole and the elastic part are formed simultaneously, and after the base part is punched, a part bending and warping from the base part is the elastic part, and a hollowed-out part formed due to warping is the positioning hole.

7. The collector ring for a motor according to claim 3, wherein a dimension of the transition part along a second direction is greater than a dimension of the welding part along the second direction, the dimension of the welding part along the second direction is greater than a dimension of the stator wire outlet end along the second direction, the second direction is perpendicular to the first direction, and the second direction is consistent with the width direction of the base part.

8. The collector ring for a motor according to claim 3, wherein the welding part is offset from the transition part toward a side where the elastic part is located.

9. A motor, the motor comprising a stator wire outlet end, and a collector ring, wherein the collector ring has a connecting end, the connecting end including a base part and a welding part which is vertical relative to the base part, the base part is provided with a positioning hole and an elastic part, the positioning hole is a through hole, the positioning hole is used to permit a stator wire outlet end of the motor to pass through,
and the elastic part is formed so as to be capable of applying an elastic force to the stator wire outlet end along a first direction serving as a length direction of the base part, so that two opposite side surfaces of the stator wire outlet end along the first direction are in close contact with the base part and the welding part, respectively the stator wire outlet end being connected to the welding part of the collector ring by welding.

10. The motor according to claim 9, wherein the base part is connected to an axial end face of a stator of the motor, and the welding part extends along an axial direction of the stator.

11. The motor according to claim 9, wherein a dimension of the positioning hole along a second direction is equal to a dimension of the stator wire outlet end along the second direction, the first direction is perpendicular to the second direction, and the second direction is consistent with a width direction of the base part.

12. The motor according to claim 9, wherein the connecting end further comprises a limiting part, the limiting part comprises a transition part and the welding part, the welding part is connected to the base part through the transition part, the limiting part and the elastic part are located on two opposite sides of the positioning hole in the first direction, and under the action of the elastic force applied by the elastic part, the stator wire outlet end can abut against the welding part.

13. The motor according to claim 12, wherein the base part and the limiting part are integrally formed.

14. The motor according to claim 9, wherein the elastic part and the base part are integrally formed.

15. The motor according to claim 9, wherein the positioning hole and the elastic part are formed simultaneously, and after the base part is punched, a part bending and warping from the base part is the elastic part, and a hollowed-out part formed due to warping is the positioning hole.

16. The motor according to claim 12, wherein a dimension of the transition part along a second direction is greater than a dimension of the welding part along the second direction, the dimension of the welding part along the second direction is greater than a dimension of the stator wire outlet end along the second direction, the second direction is perpendicular to the first direction, and the second direction is consistent with the width direction of the base part.

17. The collector ring for a motor according to claim 12, wherein the welding part is offset from the transition part toward a side where the elastic part is located.
